(19) United States
(12) Patent Application Publication
(10) Pub. No.: US 2018/0180237 A1
(43) Pub. Date: Jun. 28, 2018

(54) DIMMING CAP FOR A LAMP WITH TWO SEPARATE RADIATION SOURCES

(71) Applicant: Lumileds Holding B.V., Schiphol (NL)

(72) Inventors: Bernd Schoenfelder, Aachen (DE); Herbert Schartmann, Aachen (DE); Paul Speckens, Aachen (DE)

(21) Appl. No.: 15/739,463

(22) PCT Filed: Jun. 21, 2016
(86) PCT No.: PCT/EP2016/064284

§ 371 Date: Dec. 22, 2017

(30) Foreign Application Priority Data
Jun. 29, 2015 (DE) 20 2015 103 408.3

(51) Int. Cl. F21S 41/164; H01K 1/62; B60Q 1/14

(52) U.S. Cl. CPC F21S 41/164; B60Q 1/1415; H01K 1/62

(57) ABSTRACT

The invention refers to a dimming cap for a lamp with two separate radiation sources and, in particular, for a two-filament incandescent lamp, which has a concave shape with a base surface from which a circumferential side wall extends at least to a height H₀ above the base surface, wherein the dimming cap, in a cross section formed at a height H₀ parallel to the base surface, has a width (w₀) that is constant within a tolerance of ±0.1 mm over a first longitudinal section of the dimming cap, and which decreases over a second longitudinal section extending from the first longitudinal section to a first end of the dimming cap, and the height of the sidewall corresponds within a tolerance of ±0.1 mm over the first longitudinal section to the constant height H₀, wherein it increases over the second longitudinal section, wherein the first longitudinal section is between 70% and 98% of the length of the dimming cap in the cross-section formed at the height H₀. The invention further refers to a lamp with such a dimming cap.

### TECHNICAL APPLICATION

The present invention relates to a dimming cap for a lamp having two separate radiation sources, in particular for a two-filament incandescent lamp comprising a concave shape with a base surface, from which a circumferential side wall extends at least to a height H₀ above the base surface.

Two-filament incandescent lamps are frequently used in the field of automotive engineering, as they offer with the two filaments or spiral-wound filaments, two separate sources of radiation for dipped and main beam in the smallest space. During operation of the dipped beam, a portion of the light emitted by the corresponding filament has to be shaded so that the light emerging from the headlight via the lamp reflector remains below the glare level in the direction of travel. This shading of the light emitted by the incandescent light takes place via a suitably shaped and arranged dimming cap on the incandescent filament used for the dimmed beam.

Such dimming caps are used, for example, in H4 lamps, wherein an asymmetric distribution of the dimmed beam as specified for motor vehicles is achieved. When installed as intended in the headlight for asymmetric distribution, only the dimming cap is rotated about its longitudinal axis through a small angle relative to the horizontal. Another example is the HS1 lamp for two-wheeled vehicles, which are designed for a symmetrical distribution of the dipped beam. In these lamps as well, appropriate dimming caps may be used for the partial shading of the light emitted by the dimming filament.

The object of the present invention is to provide a dimming cap for a lamp with two separate radiation sources and, in particular, for a two-filament incandescent lamp, wherein a transition region between the dipped beam and the high beam segment in the reflector of a headlamp, is as small as possible without affecting the dimming effect.

### PRESENTATION OF THE INVENTION

The object is achieved with the dimming cap according to claim 1. Advantageous embodiments of the dimming cap are the subject of the dependent claims or may be found in the following description and the exemplary embodiments.

The proposed dimming cap comprises a concave shape with a base surface, from which a circumferential side wall extends above the base surface up to at least a fixed height H₀. The dimming cap comprises a cross-section parallel to the base surface at a height H₀ with a width that is constant over a first length of the dimming cap within a tolerance of ±0.1 mm, and which decreases over a second longitudinal section extending between the first longitudinal section and a first end of the dimming cap. The height of the side wall above the first longitudinal section lies within a tolerance of ±0.1 mm of the constant height H₀ and increases within the second longitudinal section. The dimming cap is characterized in that the first longitudinal section comprises between 70% and 98% of the length of the dimming cap in the cross-section formed at the height H₀. A third longitudinal section may also extend between the first longitudinal section and a second end opposite the first end of the dimming cap. The height of the side wall above the third longitudinal portion may correspond to the constant height H₀, but may also differ from H₀, for example it may also increase or decrease. This optional third length only serves for rounding in order to avoid sharp corners and is usually very short, in particular shorter than the second longitudinal section.

In the case of the proposed dimming cap, the width of the dimming cap and the height of the side wall are thus kept constant within the specified tolerances over the largest possible length. This corresponds to a correspondingly long horizontal course of the upper side edge of the dimming cap in a correct installation of the associated lamp in a headlamp before the width decreases and the height of the side wall accordingly increases. By means of this measure, a small transition region between the dipped beam segment and the high beam segment is achieved when used in a headlight. The dimming cap may be used both in symmetrical lamps (with a symmetrical distribution of the dipped beam) and in an asymmetrical lamps (with an asymmetrical distribution of the dipped beam).

In the proposed dimming cap, the height may increase over the entire second longitudinal section or only within an end region of this longitudinal section. Preferably, the height of the side wall increases over the entire second longitudinal section. Both the reduction in the width of the dimming cap and the increase in the height of the side wall may follow a linear or even a non-linear function. The design chosen for the particular lamp depends on the relative arrangement and dimension of the filament to be shaded by the dimming cap. According to the requirements for the respective headlight, the aim is to achieve as straight as possible a shading edge extending over a large radiation region.

The proposed dimming cap is arranged in a lamp with two separate radiation sources, and, in particular in the case of a two-filament incandescent lamp, on the incandescent filament used for producing the dipped beam. A corresponding lamp thus comprises the two filaments and a dimming cap arranged on one of the filaments. Such lamps are preferably used in the headlights of motor vehicles or two-wheeled vehicles. Of course, however, other applications are conceivable, wherein a comparable high beam and dimming effect may be achieved with a headlamp.

### BRIEF DESCRIPTION OF THE DRAWINGS

The proposed dimming cap will be briefly explained again below with reference to exemplary embodiments in conjunction with the drawings, wherein:

FIG. 1 shows a schematic representation of a first embodiment of the proposed dimming cap in cross-section at the height H₀;

FIG. 2 shows the dimming cap of the first exemplary embodiment in cross-section perpendicular thereto;

FIG. 3 shows a schematic representation of a second embodiment of the proposed dimming cap in cross-section at the height H₀;

FIG. 4 shows the dimming cap of the second embodiment in cross-section perpendicular thereto; and

FIG. 5 shows a schematic representation of the arrangement of the proposed dimming cap in a two-filament incandescent lamp.

### IMPLEMENTING THE INVENTION

FIG. 1 shows a section through a dimming cap 1 in a first embodiment of the present invention in a schematic representation. This section is parallel to the base surface of the dimming cap 1 at the height H₀. In the section, therefore, a circumferential side wall 2 may be seen, which has a constant width w₀ over a first longitudinal section L₁ of the length L of the dimming cap 1. As may be seen in the figure, this width then decreases over the remaining second longitudinal section L₂ to a first end of the dimming cap. In the present example, the width w remains constant over an extent of about 90% and then decreases over the last 10% of the length L of the dimming cap 1. A third longitudinal section L3 may also extend between the first longitudinal section L₁ and the second end of the dimming cap, which third section serves for the rounding of corners as shown in FIG. 1.

FIG. 2 shows a cross-section perpendicular to the cross-sectional plane of FIG. 1 through the middle or longitudinal axis of the dimming cap 1. In this figure, the base surface 3 and the side wall 2 may be seen in cross-section. The dashed line shows schematically the course of the upper edge of the side wall 2 outside this cross-sectional plane. It may be seen from this figure that the side wall 2 has a constant height H₀ over the first longitudinal section L₁ and only increases in height in the second longitudinal section L₂. The height H₁ is reached at the top of the dimming cap 1.

FIG. 3 shows a further exemplary embodiment of a dimming cap 1 in a schematic illustration, again in cross-section parallel to the base surface at a height H₀. In this example, the width w of the dimming cap has already decreased by some 70% of the total length L of the dimming cap.

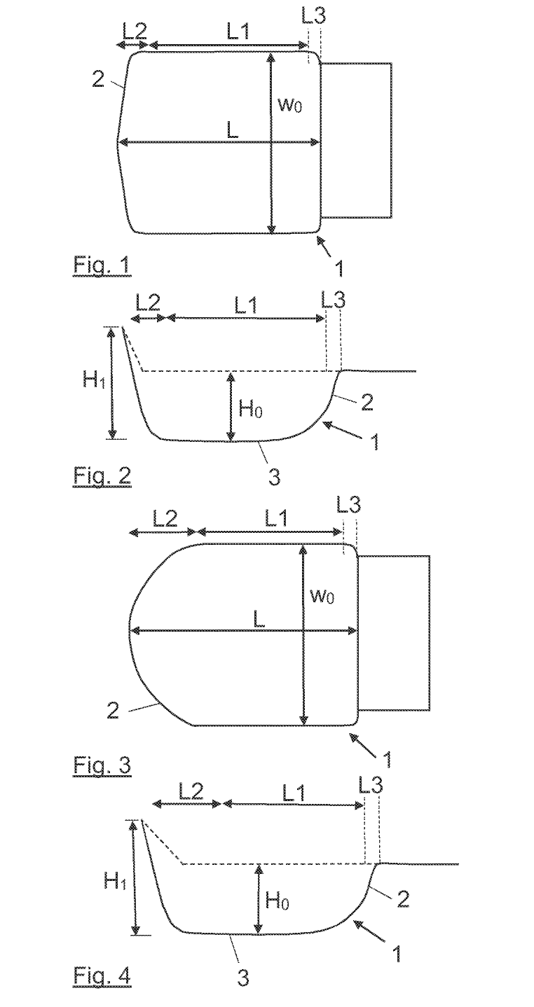

FIG. 4 again shows the cross-section perpendicular to the cross-sectional plane of FIG. 3. In this figure may be seen the constant height H₀ of the side wall over the longitudinal section L1 as well as an adjoining short section region in the longitudinal section L2. Only at the end of the dimming cap 1 does the height H of the side wall increase up to a final value H₁ at the top of the dimming cap 1. There is a small transition region between the segments for the dipped beam and high beam in the headlight due to the long horizontal course of the upper edge of the side wall 2 in both embodiments. As a result, losses in the generation of the dipped beam and high beam are minimized. Exemplary dimensions of the proposed dimming cap are in the range between 7 and 10 mm for the length L of the dimming cap, in the range between 1.8 and 3.6 mm for the height H₀, in the range between 7.5 and 9.5 mm for the constant width w₀, and in the range between 3.8 and 4.4 mm at the height H₁ at the top of the dimming cap.

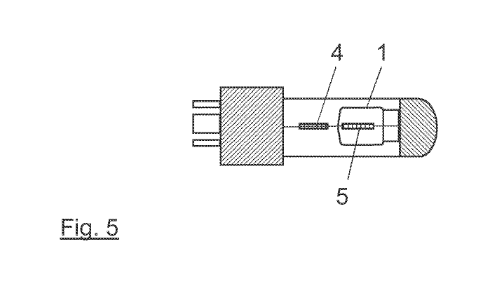

Finally, FIG. 5 shows in highly schematic form, a two-filament incandescent lamp with an embodiment of the proposed dimming cap in plan view. Two filaments 4, 5 may be seen in the figure, wherein the filament 4 arranged on the left in the figure is for the generation of the high beam, while the filament 5 arranged on the right is for the generation of the dipped beam. The proposed dimming cap 1 is arranged on the right filament 5 in order to shade the light emission of this filament 5 in the lower half.

### LIST OF REFERENCE NUMBERS

1 dimming cap
2 side wall
3 base surface
4 filament for high beam
5 filament for dipped beam
L length of the dimming cap
L₁ first longitudinal section
L₂ second longitudinal section
L₃ third longitudinal section
w width of the dimming cap
w₀ constant width of the dimming cap
H₀ constant height of the side wall
H₁ height of the side wall at the top of the dimming cap

1. Dimming cap for a lamp with two separate radiation sources and, in particular, for a two-filament incandescent lamp,
which has a concave shape with a base surface from which a circumferential side wall extends at least to a height H₀ above the base surface, wherein the dimming cap, in a cross section formed at a height H₀ parallel to the base surface, has a width (w₀) that is constant within a tolerance of ±0.1 mm over a first longitudinal section of the dimming cap, and which decreases over a second longitudinal section extending from the first longitudinal section to a first end of the dimming cap, and the height of the sidewall corresponds within a tolerance of ±0.1 mm over the first longitudinal section to the constant height H₀, wherein it increases over the second longitudinal section,
characterized in that
the first longitudinal section represents between 70% and 98% of the length of the dimming cap in the cross-section formed at the height H₀.

2. Dimming cap according to claim 1,
characterized in that
the height of the side wall increases over the entire second longitudinal section.

3. Dimming cap according to claim 1,
characterized in that
the height H₀ is between 1.8 and 3.6 mm, the length of the dimming cap is between 7 and 10 mm, and the width (w₀) in the first longitudinal section is between 7.5 and 9.5 mm.

4. Dimming cap according to claim 1,
characterized in that
the height in the second longitudinal section increases to a value H₁ that is between 3.8 and 4.4 mm.

5. Dimming cap according to claim 1,
characterized in that
the width (w₀) decreases non-linearly over the second longitudinal section.

6. Dimming cap according to claim 1,
characterized in that
the height increases non-linearly within the second longitudinal section or over the entire second longitudinal section.

7. Dimming cap according to claim 1,
characterized in that
the width (w₀) of the dimming cap, in the cross-section formed at the height H₀ parallel to the base surface, decreases over a third longitudinal section extending from the first longitudinal section to a second end of the dimming cap being opposite the first end.

8. Lamp with two separate radiation sources and, in particular, a two-filament incandescent lamp for motor vehicles or two-wheeled vehicles with two filaments, wherein a dimming cap according to claim 1 is arranged at one of the two radiation sources.
